(19) United States
(12) Patent Application Publication
(10) Pub. No.: US 2019/0202467 A1
(43) Pub. Date: Jul. 4, 2019

(54) SYSTEM AND METHOD FOR ENGAGING IN EMERGENCY AUTONOMOUS DRIVING MODE FOR ASSISTED-DRIVING VEHICLES

(71) Applicant: Pony.ai, Inc., Fremont, CA (US)

(72) Inventors: Haowen Sun, Santa Clara, CA (US); Xiang Yu, Santa Clara, CA (US); Sinan Xiao, Fremont, CA (US); Sifan Weng, Santa Clara, CA (US); Tiancheng Lou, Milpitas, CA (US); Jun Peng, Fremont, CA (US)

(21) Appl. No.: 15/862,462

(22) Filed: Jan. 4, 2018

(51) Int. Cl. B60W 50/08; G05D 1/00

(52) U.S. Cl. CPC B60W 50/082; G05D 1/0088; G05D 2201/0213; B60W 2540/22; G05D 1/0061

(57) ABSTRACT

Embodiments disclosed herein include systems and methods for engaging in an emergency autonomous driving mode for assisted-driving vehicles. The vehicle may include a non-emergency driving mode and an emergency autonomous driving mode, where the vehicle includes an electronic control unit for controlling an operation of the vehicle. The electronic control unit may determine a driving mode of the vehicle, receive a request to revert from the non-emergency driving mode to the emergency autonomous driving mode; and revert back to the non-emergency driving mode when select predetermined conditions are satisfied.

### BACKGROUND

Assisted-driving vehicles can engage in a self-driving or autonomous driving mode that are capable of sensing the environment and navigating the road without continuous human input.

Assisted-driving vehicles provide the potential advantages of decreasing traffic collision caused by human errors, such as those caused by delayed reaction time, tailgating, drinking and driving, speeding, distractions, and aggressive driving. While assisted-driving vehicles continue to advance its technology with enhanced driving control systems and safety mechanisms to ensure the reliability and safety of such vehicles, people may still prefer the option of selectively engaging and disengaging in the autonomous driving mode so that they may take control of the vehicle when appropriate.

However, in certain instances, engaging in autonomous driving mode may be safer when the driver or the vehicle detects an emergency situation (e.g., earthquake, flooding, hurricane, vehicle robbery attempt, health failure of driver, etc.). Therefore, it is critical for an autonomous vehicle to know when to engage and disengage from the emergency autonomous driving mode based on the surrounding environmental, road, and driving conditions in order to assure the safety of the driver and passengers.

### SUMMARY

Described herein are a system and a method for engaging in an emergency autonomous driving mode for assisted-driving vehicles.

In one embodiment, the disclosure describes a system including at least a non-emergency driving mode and an emergency autonomous driving mode. In some instances, the vehicle may include an electronic control unit for controlling an operation of the vehicle, where the electronic control unit may determine a driving mode of the vehicle, receive a request to revert from the non-emergency driving mode to the emergency autonomous driving mode, and revert back to the non-emergency driving mode when select predetermined conditions are satisfied.

In other instances, the request to revert from the non-emergency driving mode to the autonomous driving mode may be initiated by a driver. Furthermore, the vehicle may include an emergency button such that when a driver pushes the emergency button, the vehicle engages in the emergency autonomous driving mode.

In some instances, the request to revert from the non-emergency driving mode to the autonomous driving mode is initiated by a processor connected to the electronic control unit, such that when one or more in-vehicle devices detect a pre-determined environmental condition or physical condition of a driver, the autonomous driving mode is engaged. Additionally, by way of example, the one or more in-vehicle devices comprises sensors, cameras, navigation system, communication system, radar, and laser scanners. Furthermore, the environmental condition may include a natural disaster and dangerous road conditions and the physical condition of the driver may include an indication that the driver is physically or mentally unfit to drive the vehicle in a safe manner.

In some embodiments, the vehicle may monitor the physical condition of the driver including heart rate, blood pressure, blood sugar, reaction time, and vision. In some instances, the electronic control unit may display one or more tasks on a display screen for the driver to complete with a passing score before reverting back to the non-emergency driving mode to determine the driver's mental capacity to operate a vehicle. In some instances, the driver must complete the one or more tasks within a predetermined time period.

In some embodiments, the vehicle may override a standard driving protocol when the vehicle is engaged in the emergency autonomous driving mode. In some instances, overriding standard driving protocol comprises driving against a flow of traffic, driving through a red light, and driving over a speed limit. Furthermore, in some instances, the vehicle may override a current destination point determined by the driver and determines a new destination point. By way of example, the new destination point may include a hospital, a police station, an evacuation center, and a home.

Also described herein are methods for engaging in an emergency autonomous driving mode for assisted-driving vehicles. In one embodiment, the method includes determining whether the vehicle is in a non-emergency driving mode or an emergency autonomous driving mode, receiving a request to revert from the non-emergency driving mode to the emergency autonomous driving mode, and reverting back to the non-emergency driving mode only when select predetermined conditions are satisfied.

In one instance, the method may include receiving a request includes a driver pushing an emergency button to request the autonomous driving mode. In other instances, receiving a request includes the vehicle detecting a pre-determined environmental condition indicating unsafe driving conditions and detecting that the driver is physically or mentally unfit to drive the vehicle in a safe manner. By way of example, the select predetermined conditions include driving conditions and a driver's physical and mental capability of driving the vehicle in non-emergency driving mode.

In some embodiments, the method may further include displaying one or more tasks on a display screen for the driver to complete, wherein completing the one or more tasks reverts back to the non-emergency driving mode. In some instances, the method may also include monitoring a physical condition of the driver comprising heart rate, blood pressure, blood sugar, reaction time, and vision.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 is a schematic diagram depicting an example of an assisted-driving vehicle that includes an emergency button for selectively engaging in an emergency autonomous driving mode according to an embodiment.

FIG. 2 is a schematic diagram depicting an example of a vehicle-to-vehicle communication system according to an embodiment.

FIG. 3 is a schematic diagram depicting a user interface in the assisted-driving vehicle to display a set of tasks for the driver according to an embodiment.

FIG. 4A is a flowchart of an example of a method for engaging in an emergency autonomous driving mode unit according to an embodiment.

FIG. 4B is a flowchart of an example of a method for disengaging in an emergency autonomous driving mode unit according to an embodiment.

FIG. 5 is a flowchart of an example of a method for engaging in an autonomous driving mode unit using an emergency button according to an embodiment.

FIG. 6 is an example computing component that may be used to implement various features of embodiments described in the present disclosure.

### DETAILED DESCRIPTION

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to a system and a method for engaging in an emergency autonomous driving mode and a non-emergency driving mode for assisted-driving vehicles.

The system for engaging in an emergency autonomous driving mode for assisted-driving vehicles may include a vehicle capable of driving in an emergency autonomous driving mode and a non-emergency driving mode. In the non-emergency driving mode, the vehicle may be manually driven by a driver, optionally with various level of driver-assistance, or fully autonomous but can still take commands from the driver or can be overridden at any time by the driver. In some instances, the driver may selectively determine whether or not to engage in a non-emergency driving mode and an emergency autonomous driving mode. By way of example, the emergency autonomous driving mode may be engaged when the assisted-driving vehicle detects an emergency situation and determines that having the assisted-driving vehicle control and maneuver the assisted-driving vehicle without human input will be safer for the driver and any nearby pedestrians and surrounding drivers. Thus, the emergency autonomous driving mode may compute the safest trajectory path and navigate the driving environment with little or no direct human input.

In other instances, the driver may push a designated button, referred to herein as “emergency button”, such that when pushing the emergency button, the assisted driving vehicle engages in the emergency autonomous driving mode. Thus, when the driver detects a current or oncoming emergency scenario ahead where the driver feels incapable of safely maneuvering and driving the assisted-driving vehicle, the driver may then push the emergency button to engage the emergency autonomous driving mode. However, it should be noted that the button may be designated as any other name or label (e.g., “mode button,” “manual button,” “auto button,” “switch,” etc.).

In other instances, the assisted-driving vehicle may selectively determine whether or not to take control from the driver and revert from the non-emergency driving mode to the emergency autonomous driving mode. The assisted-driving vehicle may take over control from the driver when the assisted-driving vehicle detects certain environmental or road conditions that are dangerous and even likely to result in a vehicle collision. By way of example, such environmental conditions may include severe weather conditions (e.g., high speed winds, flash flooding, hurricanes, tornadoes, etc.), natural disasters (e.g., nearby fires, earthquakes, hurricanes, tornadoes, etc.), large crowds, extensive vehicular traffic, and the like. By way of another example, such road conditions that may make it difficult for the driver to maneuver the assisted-driving vehicle manually may include extensive road surface damage, large foreign objects placed in the middle of the road or highway, possibility of a likely collision with another vehicle or pedestrian, and the like.

Additionally, in some instances, the assisted-driving vehicle may be configured to continuously or sporadically monitor the health of the driver. When the assisted-driving vehicle detects the failing mental and physical capacity of the driver (e.g., emotional instability, heart attack, sudden loss of vision, diabetic episode, drowsiness etc.), the assisted-driving vehicle may also take control from the driver and engage in the emergency autonomous driving mode.

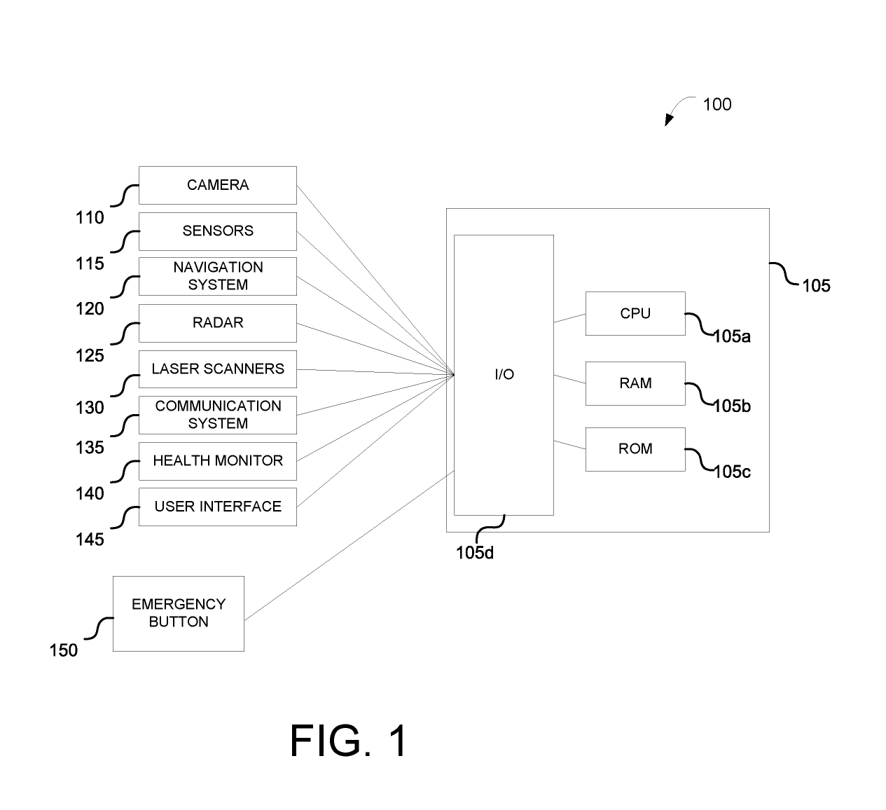

FIG. 1 is a schematic diagram depicting an example of an assisted-driving vehicle 100 that includes an emergency button 150 for selectively engaging in an emergency autonomous driving mode according to an embodiment. In the example depicted in FIG. 1, the assisted-driving vehicle 100 in the present disclosure is intended to represent a vehicle that is capable of sensing its environment and navigating with limited human input or without human input.

In one embodiment, the assisted-driving vehicle 100 may selectively engage in an emergency autonomous driving mode where the assisted-driving vehicle 100 controls the steering and direction without real time human input based on the calculations determined by the on-board vehicle processors. By way of example, the on-board vehicle processors may receive data and inputs from the on-board vehicle cameras 110, sensors 115, navigation system 120, radar 125, laser scanners 130, communication system 135, and the like. Based on the data and inputs, the assisted-driving vehicle 100 may autonomously control the necessary braking, acceleration, and steering without real time human input. Further, “real time human input” is intended to represent a human input that is needed to concurrently control wheel movement of a non-assisted-driving vehicle, such as gear shifting, steering control, braking pedal control, acceleration pedal control, clutch pedal control, and so on. In one embodiment, the assisted-driving vehicle 100 is one of regular passenger vehicle types such as sedan, SUV, hatchback, and so on. In another embodiment, the assisted-driving vehicle 100 is one of commercial vehicle types such as bus, truck, trailer, and so on.

In some instances, the assisted-driving vehicle 100 may include an electronic control unit (“ECU”) 105. The ECU 105 may include a CPU 105a, a RAM 105b, a ROM 105c, and an I/O module 105d. The RAM 105b and ROM 105c may be used as, for example, memory storage devices to store data and instructions listing conditions and threshold requirements for engaging or disengaging in the emergency autonomous driving mode and non-emergency driving mode based on select driver commands and environmental and/or road conditions. The RAM 105a and ROM 105c may also be used to store any other data and instructions necessary to operate and run the assisted-driving vehicle 100.

Additionally, the CPU 105a may perform various computations from the data gathered by the vehicle cameras 110, sensors 115, navigation systems 120, radars 125, laser scanners 130, and communications systems 135. Such computations may include determining the trajectory path the autonomous vehicle based on the GPS route guidance input from the navigation system 120. Additionally, the trajectory path of the autonomous vehicle may be continuously modified and updated by continuously factoring in the immediate environmental and road conditions surrounding the assisted-driving vehicle 100 based on the data and inputs provided by the cameras 110, sensors 115, radars 125, laser scanners 130, and communications systems 135.

In some instances, the ECU 105 may also be able to detect whether the assisted-driving vehicle 100 is turned on or off. If on, the ECU 105 may be able to determine the driving mode of the assisted-driving vehicle 100. For example, in some instances, the ECU 105 may detect the driving mode of the assisted-driving vehicle 100 based on the driver request, such as in the instance that the driver pushes the emergency button 105. By pushing the emergency button 105, the ECU 105 may instruct the assisted-driving vehicle 100 to engage in the emergency autonomous driving mode.

In other instances, the ECU 105 may receive data and inputs from the on-board vehicle cameras 110, sensors 115, navigation system 120, radar 125, laser scanners 130, communication system 135, and the like. Based on such data and inputs, the CPU 105a may determine whether the current or oncoming driving conditions are safe for manual operation. If not, the CPU 105a may signal the ECU 105 to engage in the emergency autonomous driving mode.

By way of example, detecting for such dangerous driving conditions may be determined by analyzing the one or more data gathered by the vehicle cameras 110, sensors 115, navigation systems 120, radars 135, laser scanners 125, and communications systems 130. Should the assisted-driving vehicle 100 engage in the emergency autonomous driving mode, the CPU 105a may then determine the safest trajectory route of the assisted-driving vehicle based on the data gathered. The I/O module 105d may be connected to various vehicle components, devices, and systems to determine the upcoming trajectory path and control of the assisted-driving vehicle 100. Additionally, these various vehicle components may be used individually or in combination with one another to detect the select environmental, road, and/or driving conditions in real time.

By detecting for certain objects surrounding the assisted-driving vehicle 100 utilizing the cameras 110, sensors 115, navigations system 120, radar 135, and laser scanners 125, the ECU 105 may be able to factor the presence of the identified objects and determine its potential danger to the driver in the assisted-driving vehicle 100. In some instance, this may then allow the assisted-driving vehicle to make the determination whether the assisted-driving vehicle 100 is approaching dangerous road or driving conditions (e.g., sink hole, large cracks in road, dangerous weather conditions, pedestrian crossing the road, large foreign objects in middle of the road, etc.). Additionally, in some instances, if the assisted-driving vehicle 100 is in non-emergency driving mode and the CPU 105a detects dangerous road conditions ahead, the CPU 105a may signal the assisted-driving vehicle 100 to engage in emergency autonomous driving mode. By doing so, the assisted-driving vehicle 100 may be able to better navigate the dangerous road conditions and guide the driver and passengers to safety.

In some instances, cameras 110 may be mounted in the interior and/or exterior sections of the autonomous vehicle. In some embodiments, the cameras 110 may be a still camera and/or video camera that may capture images and videos of the front, sides, and rear surrounding areas of the assisted-driving vehicle 100. The cameras 110 may be oriented to take images and videos of preceding vehicles and oncoming vehicles, as well as pedestrians, objects, and road conditions surrounding the general vicinity of the assisted-driving vehicle 100.

In some instances, images captured by the cameras 110 may be processed with object recognition software to detect certain objects of interest. By way of example, the cameras 110 may capture images and/or videos of the surrounding vehicle environment, which may include potential pedestrians, road signs, oncoming vehicles, preceding vehicles, and the like. The images and/or videos may then be processed by the CPU 105a, where they may then filtered with an object recognition software. To determine if any of the objects in the images and/or videos include objects of interest (e.g., pedestrians, road signs, oncoming vehicles, preceding vehicles, headlights, tail lights, and the like), the object recognition software may include a datastore with reference materials. By way of example, the reference materials may also include information regarding shapes, pixel intensities, lines, and other information that can be used to help further identify the objects of interest in the images and/or videos. Thus, the cameras 110 may be utilized to detect for select environmental and road conditions and signal the CPU 105a when such select conditions (e.g., dangerous road and driving conditions) are detected.

There may also be a plurality of sensors connected to the I/O module 105d, where the sensors 115 may be used to detect various road and driving conditions. By way of example, such sensors 115 may detect distance between vehicles (e.g., radar sensors), speed of current autonomous vehicle travel (e.g., accelerometer and speedometer), object detection (e.g., radar sensors), motion detection (e.g., motion sensors), moisture detection (e.g., moisture detection sensors), steering handling detection (steering wheel sensors), and the like. The sensors 115 alone or in combination with the camera 110, navigation system 120, radar 125, the laser scanners 130, and communication systems 135 may be used to collect data in real time, which may then be processed by the CPU 105a. The sensors 115 may be utilized to detect for select environmental and road conditions and signal the CPU 105a when such select conditions (e.g., dangerous road and driving conditions) are detected.

The navigation system 120 may also be connected to the I/O module 105d. The navigation system 120 may include a navigation processor, a navigation adjustment component, and a GPS component. In some embodiments, the navigation system 120 may determine the location of the assisted-driving vehicle 100 in real time. The navigation system 120 may also be configured to determine the current and upcoming road and traffic conditions using a GPS component (which may include or be a GPS receiver). In some embodiments, navigation system 120 may receive information from third party service providers, such as current traffic information, weather information, road construction information, and the like. While the navigation system 120 may provide quickest route or provide a route based on driver specifications (e.g., no toll road, no highways, no private roads, etc.), the assisted-driving vehicle 100 may also utilize the camera 110, sensors 115, radar 125, laser scanners 130, and communication systems 135 to determine the safest upcoming trajectory of the assisted-driving vehicle 100 in real time when engaged in the emergency autonomous driving mode.

A radar 125 and laser scanner 130 may also be connected to the I/O module 105d. The radar 125 may utilize electromagnetic radiation to detect other vehicles or objects located near the assisted-driving vehicle 100. Additionally, the laser scanner 130 may emit a light beam such that when the light beam is reflected back after hitting a surface of an object in the environment, objects may then be detected. Based on vehicles or objects detected via the radar 125 and laser scanner 130, the ECU 105 may determine the safest upcoming trajectory of the assisted-driving vehicle 100 in real time when the assisted-driving vehicle is engaged in the autonomous driving mode.

Additionally, in some instances, the radar 125 and the laser scanner 130 may be utilized to detect for select objects in the road or areas surrounding the assisted-driving vehicle 100 that may indicate dangerous driving conditions for the driver. When such driving conditions are detected and even supported by other data provided in conjunction with the camera 110, sensors 115, radar 125, laser scanners 130, and communication systems 135, the CPU 105a may send a signal to the ECU 105. The ECU 105 may then engage in the autonomous driving mode to transport the driver safely and away from danger.

By way of further example, the communication system 130 may also be connected to the I/O module 105d. The communication system 130 may include telematic systems, such as on-board diagnostics (OBD) systems installed within autonomous vehicles, which may be configured to access vehicle computers and transmit vehicle data to the CPU 105a. In some instances, the communication system 135 may also include a Bluetooth system to enable communication between the vehicle and the driver's mobile phone. This may allow any data collected from a mobile device, such as location information, to be transmitted to the CPU 105a for data processing.

Additionally, the communication system 130 may also include vehicle-to-vehicle communication systems and/or vehicle-to-infrastructure communications systems, which can be used to share data and information amongst assisted-driving vehicles and/or data and information from roadside units. By way of example, shared data and information may include data collected by the assisted-driving vehicle 100, such as safety information, locations of other nearby assisted-driving vehicles, location of upcoming of road-side emergencies, detection of a vehicle collision, and the like.

By way of further example, the communication systems 130 may receive important weather, traffic, and safety alerts from other vehicles, mobile devices, and organizations with the supported communication system 130. The ECU 105 may then use such gathered information to further determine whether the current or upcoming road conditions are dangerous and require the emergency autonomous driving mode to be engaged.

Furthermore in some embodiments, the communication system 130 of the assisted-driving vehicle 100 may alert other vehicles nearby of the dangerous road conditions ahead. Thus, in some instances, information received by the communication system 130 may be used to determine and assess the current and upcoming driving conditions. In the instance that the driving conditions are not safe for non-emergency driving mode based on the received communications (e.g., alert of flash flooding, hurricane, tornado, traffic collision, etc.), the ECU 105 may engage in autonomous driving mode.

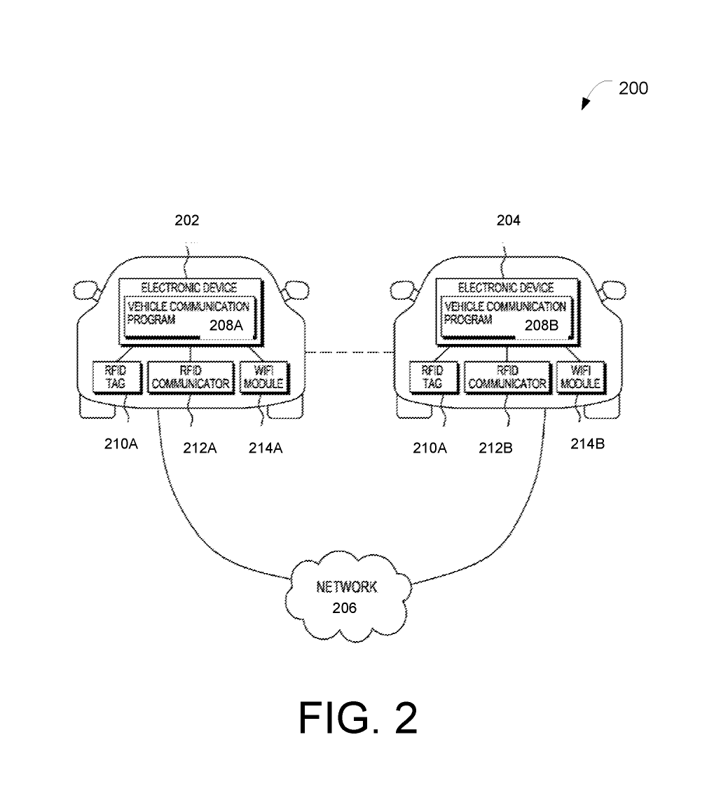

The communication system 130 is depicted in FIG. 2, which is a schematic representation of a vehicle communication system 200. In some embodiments, the distributed data processing environment may include an electronic device 202 and electronic device 204 interconnected over network 206. By way of example, the electronic devices 202 and 204 may be an ECU, a transmission control unit (TCU), an integrated vehicle computer, a laptop computer, a tablet computer, a smartphone, or any programmable electronic device capable of receiving at least inputs and communicating with other electronic devices, network 206, RFID tag 210A and 210B, RFID communicator 212A and 212B, and WIFI module 214A and 214B. The electronic device 202 may be located in a first vehicle and electronic device 204 may be located in a second vehicle.

In some embodiments, the vehicle communication program 208A and 208B may each reside in electronic devices 202 and 204. The vehicle communication program 208 may have the ability to send and receive messages concerning safety, environment, road, and driving conditions. Additionally, the vehicle communication program 208A can determine whether electronic devices 204 with vehicle communication 208B is in the vicinity and then send the information.

RFID tag 210A and 210B may be radio-frequency identification tags which may respectively communicate with vehicle communication program 208A and 210B to provide vehicle information. In one embodiment, the vehicle information can include vehicle identification number, where communication program 308 may have the ability to determine information about the vehicle, such as the make and model of the vehicle. The RFID communicators 212A and 212B may communicate with communication program 208A and 208B to send messages, receive messages, and identify vehicle in the vicinity based on the RFID tags 210A and 210B.

In another embodiment, the Wi-Fi module 214A and 214B can respectively communication with vehicle communication program 208A and 208B. For example, the Wi-Fi module 214A and 214B allow vehicle communication programs 208A and 208B to send and receive messages between electronic devices 202 and 204. The Wi-Fi module 214A can be associated with a vehicle and Wi-Fi module 214B can be associated with another vehicle, where each Wi-Fi module 214 utilizes a unique IP address.

In general, network 206 can be any combination of connections and protocols that can support communications between electronic device 202 and 204. Network 206 can include, for example, a local area network (LAN), a wide area network (WAN), such as the internet, a cellular network, or the combination of the preceding, and can further include wired, wireless, and/or fiber optic connections.

Referring back to FIG. 1, in some embodiments, the assisted-driving vehicle 100 may include a health monitor 140. The health monitor 140 may be located on the steering wheel or anywhere within the vicinity of the driver's seat. In some instances, the health monitor 140 may assess the physical well-being and his or her capacity to manually drive the assisted-driving vehicle 100 safely. By way of example, the health monitor 140 may include various sensors to monitor one or more health conditions of the driver. By way of example, health monitor 140 may monitor at least one of respiratory rate, heart rate, body temperature, and blood sugar.

In some embodiments, if the health monitor 140 detects the failing health condition of the driver such that he or she is no longer able to manually operate the assisted-driving vehicle 100 safely, the ECU 105 may engage in the emergency autonomous driving mode. Additionally, the ECU 105 may further utilize the on-board communication system 135 to call emergency responders, nearby hospital facility, stored emergency contact, etc. Additionally, assisted-driving vehicle 100 may engage in the autonomous driving mode and re-route the travel destination to the nearest emergency room, hospital facility, stored home address, or an address requested by the driver or passenger.

In other instances, the driver may suddenly feel physically ill and determine that he or she is no longer able to manually operate the assisted-driving vehicle 100 safely. In the instance that the health monitor 140 does not detect the physical ailment of the driver, the driver may push the emergency button 150. By doing so, the assisted-driving vehicle 100 may then engage in the emergency autonomous driving mode. The driver may then request that the assisted-driving vehicle re-route the travel destination to the nearest emergency room, hospital facility, stored home address, or an address requested by the driver or passenger.

It should be noted that the driver may push the emergency button 150 whenever the driver detects a sudden situation where he or she no longer feels confident in safely operating the assisted-driving vehicle 100. As such, the emergency button 150 is not limited to scenarios where the driver feel physically unwell. Instead, such exemplary emergency situations as mentioned above, may include driving in extreme weather conditions, approaching foreign objects or pedestrians in the road, detecting likelihood of potential collision with another vehicle, etc. As such, while the assisted-driving vehicle 100 may automatically engage in the autonomous driving mode when it detects dangerous driving conditions, the driver may also make his or her own subjective determination as to whether or not the driver is facing an emergency situation.

In some embodiments, when the assisted-driving vehicle 100 is engaged in the emergency autonomous driving mode, the assisted-driving vehicle 100 may change the autonomous driving behavior of the vehicle. For example, because the assisted-driving vehicle 100 is driving with the indication that an emergency scenario is present or likely imminent, the assisted-driving vehicle 100 may operate the vehicle accordingly. For example, in the instance that the assisted-driving vehicle 100 engages in the emergency autonomous driving mode because of a detection of a natural disaster or failing health of the driver, the assisted-driving vehicle 100 may drive over a curb in order to proceed past a fallen tree or building, operate at a certain range above the speed limit, run past a red light, drive off-road, driving against the flow of traffic, etc.

Additionally, the assisted-driving vehicle 100 may continue to operate under limited capabilities when engaged in the emergency autonomous driving mode. For example, when operating in the normal autonomous driving mode, the assisted-driving vehicle may not operate when it detects in-vehicle camera or sensor damage, low tire pressure levels, cracked windows, and the like. However, when the assisted-driving vehicle 100 is engaged in the emergency autonomous driving mode, the vehicle may continue operate even under such limited capabilities because the vehicle detects an emergency scenario.

In some instances, the driver may wish to disengage the emergency autonomous driving mode and revert back to non-emergency driving mode. The driver may request the non-emergency driving mode by selecting the necessary button, switch, or voice command to re-engage in the non-emergency driving mode. In some instances, the assisted-driving vehicle 100 may only revert back to non-emergency driving mode if the assisted-driving vehicle 100 determines that the road and driving conditions are sufficiently safe for manual driving. Additionally, is some embodiments, reverting back to the non-emergency driving mode after the assisted-driving vehicle is engaged in the emergency autonomous driving mode may require a series of pre-checks to confirm that the surrounding conditions are sufficiently safe for operating in the non-emergency driving mode.

By way of example, the assisted-driving vehicle 100 may revert to emergency autonomous driving mode in the instance that the health monitor 140 detects that the driver has a sudden spike in temperature and heart rate. The heart monitor 140 may determine that the driver is undergoing a sudden emotional shock or cardiac arrest. Upon such a determination, the assisted-driving vehicle 100 may then take control away from the driver and engage in emergency autonomous driving mode. In the instance that the driver was merely having a minor panic episode that has passed, the driver may wish to regain control and engage in the non-emergency driving mode. When the driver wishes to revert back to the non-emergency driving mode, the assisted-driving vehicle 100 may require re-checking and confirming the driver's stable vitals and health condition via the health monitor 140. Only when the driver's vitals are within an acceptable range indicating that the driver is physically competent to drive may the assisted-driving vehicle 100 revert back to the requested non-emergency driving mode.

Furthermore, the assisted-driving vehicle 140 may further request that the driver complete one or more tasks on the user interface 145 to further ensure that the driver is mentally capable and alert to manually drive the assisted-driving vehicle 140. Thus, the assisted-driving vehicle 140 may require the driver to prove he or she is mentally alert and capable of manually operating the assisted driving vehicle 100.

In some embodiments, in order to test the driver's sufficient mental capacity to operate the assisted-driving vehicle 100 manually, the driver may be required to complete one or more tasks on a user interface 145. The tasks may be configured to determine whether the driver has sufficient motor skills, reactionary time, and vision clarity to manually operate the assisted-driving vehicle 100 in a safe manner. By way of example, some of the tasks may include following basic directions to ensure that the driver is alert and able to complete basic motor functions (e.g., tap the touch screen a select number of times, tap the moving targets on the touch screen, follow the moving target on the touch screen with a finger, calculate basic mathematical questions, etc.).

In some embodiments, the driver may be required to finish the one or more tasks within a set time duration in order to be deemed competent to drive the assisted-driving vehicle 100. By way of further example, the driver may be required to obtain a certain minimum passing score in order to be deemed physically and mentally competent to manually operate the assisted-driving vehicle 100.

In further embodiments, additional pre-checks may be required before the assisted-driving vehicle 100 reverts back to non-emergency driving mode after operating in the emergency autonomous driving mode. For example, the driver may be required to satisfy the physical and mental competency requirements via the health monitor 140 and completion of tasks via the user interface 145. Additionally, a third party vehicle monitoring system or program may call the driver to confirm that the driver is okay and fit to operate the assisted-driving vehicle 100. Other pre-check qualifications made be included in order to determine the physical and mental capacity of the driver.

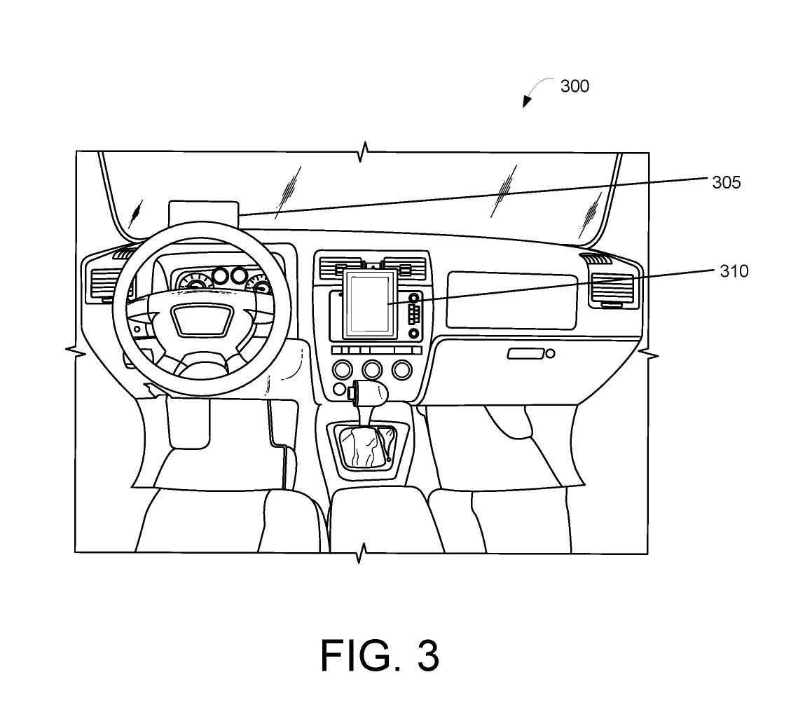

FIG. 3 is a schematic diagram depicting a user interface 305, 310 in the assisted-driving vehicle 300 to display a set of tasks for the driver according to an embodiment. In the example provided in FIG. 3, the assisted-driving vehicle may have one or more user interfaces 305, 310. By way of example, the user interface 305 may be located in front of the driver so that it is within the driver's line of vision of the road immediately ahead. This may allow the user to view and interact with the user interface 305 without having to completely remove his or her eyes from the road immediately ahead.

In other instances, the assisted-driving vehicle 300 may have another user interface 310 that is located towards the center of the front instrument panel. One or both of the user interfaces 305, 310 may display the one or more tasks to the driver that need to be completed in order to assure the physical and mental capacity of the driver.

By way of example, the user interface 305, 310 may be a touch screen. This may allow the assisted-driving vehicle 300 to display tasks requiring some form of driver interaction to assess and determine the driver's physical and mental capacity. In some instances, the tasks may be displayed on the user interface 305, 310 only when the assisted-driving vehicle 300 detects that the vehicle is stopped and not in motion.

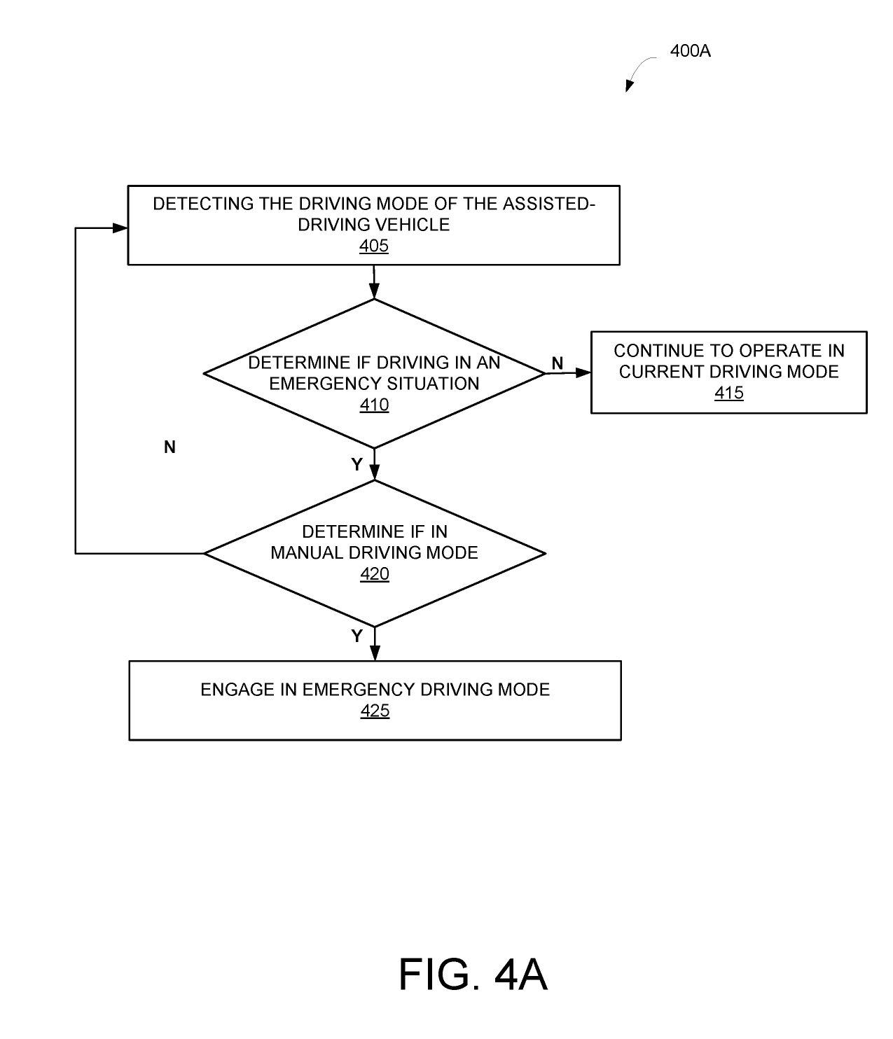

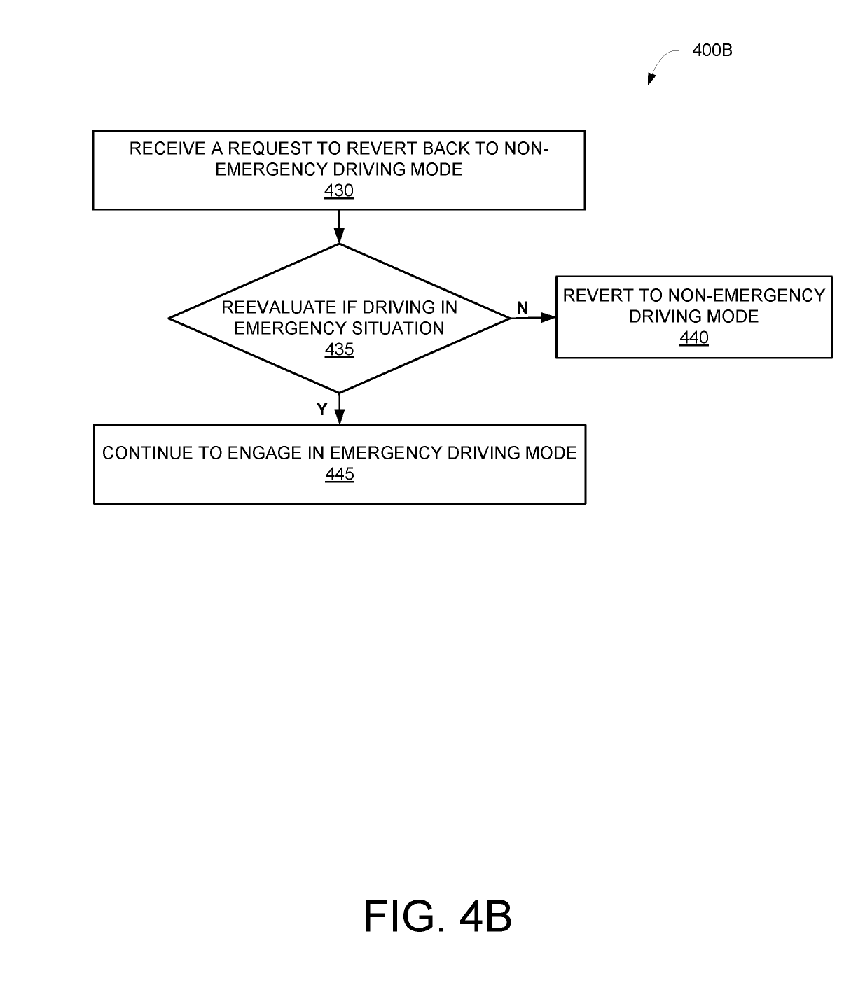

FIG. 4A is a flowchart of an example of a method 400A for engaging in an autonomous driving mode unit according to an embodiment. The method 400A may include detecting the driving mode of the assisted-driving vehicle at step 405. Thus, the assisted-driving vehicle may detect whether it is currently operating in a non-emergency driving mode or in an emergency autonomous driving mode. Additionally, the assisted-driving vehicle may continue to operate at the currently selected driving mode or may revert back and forth depending on a driver's active selection of the driving mode.

Next at step 410, the assisted-driving vehicle may determine whether it is currently operating in dangerous driving conditions. The assisted-driving vehicle may utilize its various on-board vehicle devices (e.g., cameras, sensors, navigation system, radar, laser scanners, communication system) to determine the surrounding environment and road conditions near the assisted-driving vehicle.

In the instance that the assisted-driving vehicle does not detect any current or potential dangerous driving conditions, the assisted-driving vehicle may continue to operate in its current driving mode, as indicated at step 415.

In the instance that the assisted-driving vehicle detects driving conditions that are dangerous and even life-threatening, the assisted-driving vehicle may determine whether or not it is in a non-emergency driving mode at step 420. If the assisted-driving vehicle determines that it is currently in the non-emergency driving mode, the assisted-driving vehicle may switch to the emergency autonomous driving mode at step 425. By engaging in the emergency autonomous driving mode, the assisted-driving vehicle may be better able to react to the driving conditions and detect a safer driving path more quickly and effectively than a human driver.

FIG. 4B is a flowchart of an example of a method 400B for disengaging an emergency autonomous driving mode according to an embodiment. By way of example, the assisted-driving vehicle may be currently operating in the emergency autonomous driving mode because the assisted-driving vehicle or driver detected dangerous driving conditions and thus engaged in the emergency autonomous driving mode, as further discussed in FIG. 4A. However, in some instances, the driver may wish to re-engage in the non-emergency driving mode. As such, at step 430, the assisted-driving vehicle may receive a request from the driver to take back control of the assisted-driving vehicle and operate in the non-emergency driving mode.

At step 435, the assisted-driving vehicle may make an assessment to determine if the current driving conditions are dangerous or no longer dangerous. In the instance that the assisted-driving vehicle no longer detects dangerous driving conditions, the assisted-driving vehicle may approve the driver's request to revert back to the non-emergency driving mode at step 440. By way of example, to determine whether or not the assisted-driving vehicle is potentially operating in dangerous road conditions, the assisted driving vehicle may utilize its on-board vehicle cameras, sensors, navigation system, radar, laser scanners, communication system, and the like to detect its surrounding circumstances.

In other instances, the assisted-driving vehicle may require the driver to input his or her vital signs utilizing the vehicle's health monitor to determine whether or not the driver is physically competent to operate the assisted-driving vehicle. Additionally, the assisted-driving vehicle may further require the driver to complete one or more tasks to determine whether or not the driver is mentally competent to operate the assisted-driving vehicle. Thus, only when the assisted-driving vehicle determines that the driver is both physically and mentally competent will the assisted-driving vehicle revert back to the non-emergency driving mode.

Additionally, in the instance that the assisted-driving vehicle continues to detect dangerous driving conditions where the assisted-driving vehicle may be better able to react to the driving conditions and detect a safer driving path more quickly and effectively than a human driver, the assisted-driving vehicle may deny the driver's request to manually operate the assisted-driving vehicle at step 445. At such at instance, the assisted-driving vehicle may continue to operate in the emergency autonomous driving mode.

However, in other embodiments, when the driver requests to revert back to the non-emergency driving mode at step 430, the assisted-driving vehicle may grant the driver's request and revert back to the non-emergency driving mode whenever such a request is initiated by the driver.

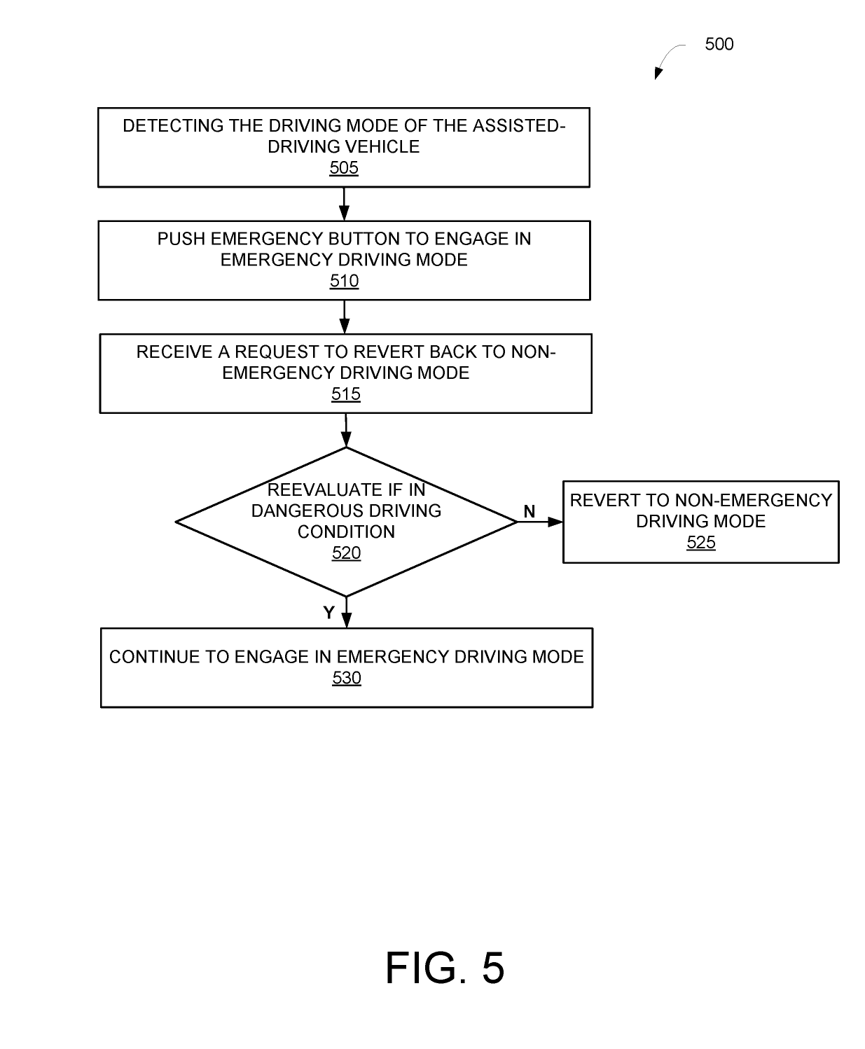

FIG. 5 is a flowchart of an example of a method 500 for engaging in an autonomous driving mode unit using an emergency button according to an embodiment. The method 500 may include detecting the driving mode of the assisted-driving vehicle at step 505. Thus, the assisted-driving vehicle may detect whether it is currently operating in a non-emergency driving mode or in an emergency autonomous driving mode.

Next at step 510, the driver may push the emergency button when he or she detects an emergency situation and no longer feels sufficiently capable of operating the vehicle in the non-emergency driving mode. Upon pushing the emergency button, the assisted-driving vehicle may engage in the emergency autonomous driving mode.

After engaging in the emergency autonomous driving mode, the driver may wish to re-engage in the non-emergency driving mode. As such, at step 515, the assisted-driving vehicle may receive a request from the driver to take disengage the emergency autonomous driving mode and operate in the non-emergency driving mode.

At step 520, the assisted-driving vehicle may make an assessment to determine if the current driving conditions are dangerous. In the instance that the assisted-driving vehicle no longer detects dangerous driving conditions, the assisted-driving vehicle may approve the driver's request to revert back to the non-emergency driving mode at step 525. By way of example, to determine whether or not the assisted-driving vehicle is potentially operating in dangerous road conditions, the assisted driving vehicle may utilize its on-board vehicle cameras, sensors, navigation system, radar, laser scanners, communication system, and the like to detect its surrounding circumstances.

In other instances, the assisted-driving vehicle may require the driver to input his or her vital signs utilizing the vehicle's health monitor to determine whether or not the driver is physically competent to operate the assisted-driving vehicle. Additionally, the assisted-driving vehicle may further require the driver to complete one or more tasks to determine whether or not the driver is mentally competent to operate the assisted-driving vehicle. Thus, in some instances, only when the assisted-driving vehicle determines that the driver is both physically and mentally competent will the assisted-driving vehicle revert back to the non-emergency driving mode.

Additionally, in the instance that the assisted-driving vehicle continues to detect dangerous driving conditions where the assisted-driving vehicle may be better able to react to the driving conditions and detect a safer driving path more quickly and effectively than a human driver, the assisted-driving vehicle may deny the driver's request to manually operate the assisted-driving vehicle at step 530. At such at instance, the assisted-driving vehicle may continue to operate in the emergency autonomous driving mode.

However, in other embodiments, when the driver requests to revert back to the non-emergency driving mode at step 515, the assisted-driving vehicle may grant the driver's request and revert back to the non-emergency driving mode whenever such a request is initiated by the driver.

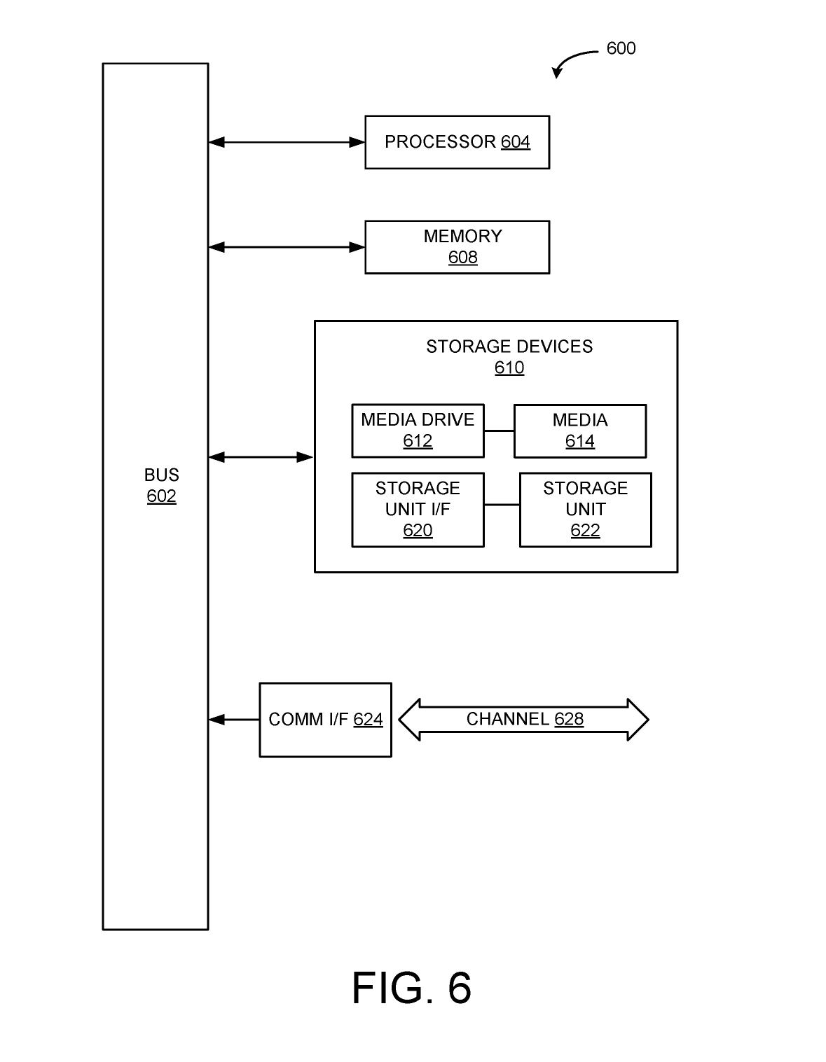

As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up navigation system 614 and its component parts, navigation server/network 624, and controller 650. Processor 604 might be implemented using a general-purpose or special-purpose processing engine such as, for example, a microprocessor, controller, or other control logic. Processor 504 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 504.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as an Ethernet, network interface card, WiMedia, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system comprising:
a vehicle configured to drive in a non-emergency driving mode and an emergency autonomous driving mode, where the vehicle comprises:
an electronic control unit for controlling an operation of the vehicle, wherein the electronic control unit:
determines a driving mode of the vehicle;
receives a request to revert from the non-emergency driving mode to the emergency autonomous driving mode; and
reverts back to the non-emergency driving mode when select predetermined conditions are satisfied.

2. The system of claim 1, wherein the request to revert from the non-emergency driving mode to the autonomous driving mode is initiated by a driver.

3. The system of claim 2, further comprising an emergency button such that when a driver pushes the emergency button, the vehicle engages in the emergency autonomous driving mode.

4. The system of claim 1, wherein the request to revert from the non-emergency driving mode to the autonomous driving mode is initiated by a processor connected to the electronic control unit, such that when one or more in-vehicle devices detect a pre-determined environmental condition or physical condition of a driver, the autonomous driving mode is engaged.

5. The system of claim 4, wherein the one or more in-vehicle devices comprises sensors, cameras, navigation system, communication system, radar, and laser scanners.

6. The system of claim 4, wherein the environmental condition comprises a natural disaster or a dangerous road condition.

7. The system of claim 4, wherein the physical condition of the driver comprises an indication that the driver is physically or mentally unfit to drive the vehicle in a safe manner.

8. The system of claim 7, wherein the vehicle monitors the physical condition of the driver comprising heart rate, blood pressure, blood sugar, reaction time, and vision.

9. The system of claim 8, wherein the electronic control unit displays one or more tasks on a display screen for the driver to complete with a passing score before reverting back to the non-emergency driving mode.

10. The system of claim 9, wherein the driver must complete the one or more tasks within a predetermined time period.

11. The system of claim 1, wherein the vehicle overrides standard driving protocol when the vehicle is engaged in the autonomous driving mode.

12. The system of claim 11, wherein overriding standard driving protocol comprises driving against a flow of traffic, driving through a red light, and driving over a speed limit.

13. The system of claim 11, wherein the vehicle overrides a current destination point determined by the driver and determines a new destination point.

14. The system of claim 12, wherein the new destination point comprises a hospital, a police station, an evacuation center, and a home.

15. A method for operating a vehicle comprising:
determining whether the vehicle is in a non-emergency driving mode or an emergency autonomous driving mode;
receiving a request to revert from the non-emergency driving mode to the emergency autonomous driving mode; and
reverting back to non-emergency driving mode only when select predetermined conditions are satisfied.

16. The method of claim 15, wherein receiving a request comprises a driver pushing an emergency button to request the autonomous driving mode.

17. The method of claim 15, wherein receiving a request comprises the vehicle detecting a pre-determined environmental condition indicating unsafe driving conditions and detecting that the driver is physically or mentally unfit to drive the vehicle in a safe manner.

18. The method of claim 15, further comprising displaying one or more tasks on a display screen for the driver to complete, wherein completing the one or more tasks reverts back to the non-emergency driving mode.

19. The method of claim 15, wherein the select predetermined conditions comprise driving conditions and a driver's physical and mental capability of driving the vehicle in non-emergency driving mode.

20. The method of claim 15, further comprising monitoring a physical condition of the driver comprising heart rate, blood pressure, blood sugar, reaction time, and vision.
